(19) United States
(12) Patent Application Publication
(10) Pub. No.: US 2021/0329097 A1
(43) Pub. Date: Oct. 21, 2021

(54) RADIO-FREQUENCY DATA STREAM PROCESSING AND VISUALIZATION

(71) Applicant: Parsons Corporation, Centreville, VA (US)

(72) Inventors: Samantha S. Palmer, Henrico, VA (US); Joseph Payton, Fredericksburg, VA (US)

(73) Assignee: Parsons Corporation, Centreville, VA (US)

(21) Appl. No.: 17/231,327

(22) Filed: Apr. 15, 2021

Related U.S. Application Data
(60) Provisional application No. 63/012,549, filed on Apr. 20, 2020.

(51) Int. Cl. H04L 29/08

(52) U.S. Cl. CPC H04L 67/327

(57) ABSTRACT

Dynamic and reconfigurable data paths for data stream processing and visualization is hereafter described by way of example. Data analytics on streaming data is conducted upon the identification of data processing needs or requirements. As these needs are recognized data paths are independently formed providing each data processing functionality with access to a common data source As requirements change, as new data processing functionalities are requested or existing functionalities are terminated, a connection manager modifies the existing data path architecture while maintaining data paths for ongoing data processing.

### RELATED APPLICATION

The present application relates to and claims the benefit of priority to U.S. Provisional Patent Application No. 63/012,549 filed 20 Apr. 2020 which is hereby incorporated by reference in its entirety for all purposes as if fully set forth herein. The present application is further related to commonly assigned U.S. patent application Ser. No. 16/996,322.

### BACKGROUND OF THE INVENTION

### Field of the Invention

Embodiments of the present invention relate, in general, to data processing and more particularly to dynamic configuration of data paths for data stream processing.

### Relevant Background

A data path is a set of functional units that carry out data processing operations. Upon recognizing a set of processes, including data analytics and visualization processes, a path is established by which the identified procedures can access data. The data may be batched or streaming. As the data flows to each process, each conducts is data processing actions until the data flow ceases or the process is terminated.

The paths themselves are, however, static. To add additional resources or data processing functionalities a new data path structure must be established and reinstituted. The streaming data, if only momentarily, must stop and then be redirected according to a new path, and processes reinitiated. What is needed is an ability to allow for reconfiguration of data and signal processing of streaming data while the data remains flowing to already established functionalities. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Dynamic and reconfigurable data paths for data stream processing and visualization are independently formed providing each data processing functionality unfettered access to a common data source. As new data processing functionalities are requested or existing functionalities terminated, data paths are reconfigured all while maintaining existing data paths for ongoing data processing.

A method for data flow management according to one embodiment of the present invention begins by receiving from a data source, a continuous data flow. A set of data processes operable on the continuous data flow is thereafter identified based on a requirement or need. For each identified data process in the set of data processes a data process communication protocol is determined. The process continues by configuring, for each identified data process in the set of data processes, a data flow path for the continuous data flow. Each data flow path is based on the data process communication protocol for that data process.

For each identified data process in the set of data processes the continuous flow of data is sent according to the communication protocol for that data process. And responsive to a new requirement or need for different data processing, the set of data process, and thus the data paths, are reconfigured while maintaining the continuous flow of data to ongoing operations.

In other embodiments, the methodology described above includes features including wherein the data source is a historical data file or wherein the data process communication protocol for each identified data process is based on a data volume requirement for that identified data process. Each data process communication protocol being selected from a predetermined list is another feature as is each data flow path being configured independently from each other data flow path. Yet, in another version of the present invention, one or more data flow paths can be dependent on one or more other data flow paths.

Another aspect of the present invention is that a single data flow path can be associated with two or more data processes. The data processes can be associated with differing types of communication protocols as well. For example, in one version of the present invention the data process communication protocol for at least one data process is a thread within an identified data process. In another version the data process communication protocol is an inter-process communication on a common machine. While in yet another version the data process communication protocol for at least one data process is a TCP/IP communication across a network such as a wide area network or the Internet. This same expanse can be covered in another version of the present invention using a UDP communication protocol.

The present invention is dynamic and according to one embodiment, responsive to the set of data processes being modified while doing so, the system maintains the data flow to data processes in the set of data processes that are unaltered. These data paths and communication protocols are configured by invoking a call to the identified data process based on accepted input parameters maintained in a data process communication protocol registry.

A system for data flow management according to one embodiment of the present invention, includes a data source configured to deliver a continuous data flow and a set of data processes formed from one or more available data processes operable on the continuous data flow. This set of process is based on a requirement or need.

The system also includes a data process communication protocol registry having a data process communication protocol for each identified data process in the set of available data processes. A data flow path for the continuous data flow is configured for each identified data process with the data flow path based on the data process communication protocol for that data process as listed in the communication protocol registry.

A processor coupled to a non-transitory computer-readable storage medium includes a program of instructions that when executed by the processor cause the processor to send the continuous data flow to each identified data process in the set of data processes based on the communication protocol for that data process. The instructions also direct the processor to reconfiguring the set of data processes based on a new requirement while maintaining the continuous data flow to existing ongoing processes.

The data process communication protocol for each identified data process described above is, in one embodiment, based on a data volume requirement for that identified data process. Recall, each data flow path is independent from each other data flow path in one embodiment while in another embodiment a single data flow path is associated with two or more data processes.

The present invention is operable to create data paths using a plurality of communication protocols including, at least one data process is a thread within an identified data process, an inter-process communication on a common machine, a TCP/IP or UDP communication across a network. As with the methodology described above, the data paths associated with the present invention are dynamically reconfigurable responsive to the set of data processes being changed. While the data paths are reconfigured the data flow to unmodified, ongoing data processes in the set of data processes is unaltered.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 depicts an exemplary data path for the quadratic equation as would be known by one of reasonable skill in the relevant art;

FIG. 2 is a block diagram of a network environment for data stream processing and visualization according to one embodiment of the present invention;

FIG. 3 is an exemplary functional data flow diagram showing a plurality of machines and processes in accordance with one embodiment of the present invention;

FIG. 4 is an expanded view of a connection manager forming one segment of a data path according to one embodiment of the present invention;

FIG. 5 is one embodiment of a methodology for data stream processing and visualization according to the present invention;

FIG. 6 is an exemplary data path for data stream processing and visualization according to one embodiment of the present invention;

FIG. 7 is a block diagram of a computer system suitable for implementation of one or more embodiments of data stream processing and visualization.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

Dynamic and reconfigurable data paths for data stream processing and visualization is hereafter described by way of example. Data analytics on streaming data is conducted, in one embodiment of the present invention, upon the identification of data processing needs or requirements. As these needs are recognized data paths are independently formed providing each data processing functionality with access to a common data source. As requirements change, as new data processing functionalities are requested, or as existing functionalities are terminated, a connection manager modifies the existing data path architecture while maintaining data paths for ongoing data processing.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined herein all terms (including technical and scientific terms) used in this disclosure have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

To provide clarity the following terms are understood to have the following meaning.

Data path—A data path is a collection of functional units such as arithmetic logic units or multipliers that perform data processing operations.

IPC or Inter-process Communication—In computer science, inter-process communication refers specifically to the mechanisms an operating system provides to allow the processes to manage shared data. Typically, applications can use IPC, categorized as clients and servers, where the client requests data and the server responds to client requests. Many applications are both clients and servers, as commonly seen in distributed computing.

Listener—listeners, also called event handlers, receive an event notification from the source.

Communication Protoco—A communication protocol is a system of rules that allow two or more entities of a communications system to transmit information via any kind of variation of a physical quantity. The protocol defines the rules, syntax, semantics and synchronization of communication and possible error recovery methods. Protocols may be implemented by hardware, software, or a combination of both. Communicating systems use well-defined formats for exchanging various messages. Each message has an exact meaning intended to elicit a response from a range of possible responses pre-determined for that particular situation. The specified behavior is typically independent of how it is to be implemented. Communication protocols have to be agreed upon by the parties involved. To reach an agreement, a protocol may be developed into a technical standard. A programming language describes the same for computations, so there is a close analogy between protocols and programming languages: protocols are to communication what programming languages are to computations. An alternate formulation states that protocols are to communication what algorithms are to computation.

Data Process or Data processing—Generally, the collection and manipulation of items of data to produce meaningful information. Data processing may include, but is not limited to, validation (ensuring that supplied data is correct and relevant), sorting (arranging items in some sequence and/or in different sets), summarization (reducing detailed data to its main points), aggregation (combining multiple pieces of data), analysis (collection, organization, analysis, interpretation and presentation of data), reporting (list detail or summary data or computed information), visualization (dealing with the graphic representation of data) and classification (separation of data into various categories). Data processes have separate address spaces, whereas threads share their address space. Processes generally interact through system-provided inter-process communication mechanisms

Streaming Data—Data that is generated continuously by thousands of data sources, which typically send in the data records simultaneously, and in small sizes (order of Kilobytes). Streaming data includes a wide variety of data such as log files generated by customers using your mobile or web applications, ecommerce purchases, in-game player activity, information from social networks, financial trading floors, or geospatial services, telemetry from connected devices or instrumentation in data centers and the like. This data needs to be processed sequentially and incrementally on a record-by-record basis or over sliding time windows and used for a wide variety of analytics including correlations, aggregations, filtering, and sampling. Information derived from such analysis gives visibility into many aspects of their business and customer activity such as—service usage (for metering/billing), server activity, website clicks, and geo-location of devices, people, and physical goods—and enables them to respond promptly to emerging situations. For example, businesses can track changes in public sentiment on their brands and products by continuously analyzing social media streams and respond in a timely fashion as the necessity arises. Examples of streaming data include:
Sensors in transportation vehicles, industrial equipment, and farm machinery send data to a streaming application. The application monitors performance detects any potential defects in advance and places a spare part order automatically preventing equipment down time.
A financial institution tracks changes in the stock market in real time, computes value-at-risk, and automatically rebalances portfolios based on stock price movements.
A real-estate website tracks a subset of data from consumers' mobile devices and makes real-time property recommendations of properties to visit based on their geo-location.
A solar power company has to maintain power throughput for its customers or pay penalties. It implemented a streaming data application that monitors of all of panels in the field, and schedules service in real time, thereby minimizing the periods of low throughput from each panel and the associated penalty payouts.
A media publisher streams billions of clickstream records from its online properties, aggregates and enriches the data with demographic information about users, and optimizes content placement on its site, delivering relevancy and better experience to its audience.
An online gaming company collects streaming data about player-game interactions and feeds the data into its gaming platform. It then analyzes the data in real-time, offers incentives and dynamic experiences to engage its players.
Radio Frequency spectrum operations collect and analyze streaming data regarding the spectrum efficiency and communication/data conveyance efficacy.

Callback Registry—Registering a callback function enables an external entity to call a functionality. A callback registry maintains a list of callback functions should an external entity point to that particular function.

IP—Internet Protocol. Occupies layer-3 in the TCP and OSI Model. The Internet Protocol is responsible for ensuring packets are sent to the correct destination.

IPv4—Internet protocol version 4, with a 32-bit address space.

OSI Model—Open Systems Interconnection model, a standard characterization of functional layers of networking using seven layers as opposed to the four layers of the TCP model.

NAT—Network Address Translation, a technology used prolifically to connect local area networks to the public Internet. NAT enables a plurality of servers (computers) to interact with the public internet via a single external IPv4 address.

TCP—Transmission Control Protocol, a stream-oriented, reliable-delivery data transfer protocol. The Transmission Control Protocol provides a communication service at an intermediate level between an application program and the Internet Protocol. It provides host-to-host connectivity at the transport layer of the Internet model. An application does not need to know the particular mechanisms for sending data via a link to another host, such as the required IP fragmentation, to accommodate the maximum transmission unit of the transmission medium. At the transport layer, (layer 4 in the OSI model) TCP handles all handshaking and transmission details and presents an abstraction of the network connection to the application typically through a network socket interface.

Socket—A network Socket is an endpoint instance, defined by a hostname or IP address and a port, for sending or receiving data within a node on a computer network. A socket is a representation of an endpoint in networking software or protocol stack and is logically analogous to physical female connections between two nodes through a channel wherein the channel is visualized as a cable having two mail connectors plugging into sockets at each node. For two machines on a network to communicate with each other, they must know each other's endpoint instance (hostname/IP address) to exchange data.

Tunnel or Tunneling Protocol (also referred to herein as a channel)—In computer networks, a tunneling protocol is a communications protocol that allows for the movement of data from one network to another. It involves allowing private network communications to be sent across a public network (such as the Internet) through a process called encapsulation. Because tunneling involves repackaging the traffic data into a different form, perhaps with encryption as standard, it can hide the nature of the traffic that is run through a tunnel. The tunneling protocol works by using the data portion of a packet (the payload) to carry the packets that actually provide the service. Tunneling uses a layered protocol model such as those of the OSI or TCP/IP protocol suite, but usually violates the layering when using the payload to carry a service not normally provided by the network. Typically, the delivery protocol operates at an equal or higher level in the layered model than the payload protocol.

Port—A Port is opening on a machine through which data can flow.

UDP—User Datagram Protocol, is a not-necessarily-in-order datagram delivery protocol, used over IP. UDP uses a simple connectionless communication model with a minimum of protocol mechanisms. UDP provides checksums for data integrity, and port numbers for addressing different functions at the source and destination of the datagram. It has no handshaking dialogues, and thus exposes the user's program to any unreliability of the underlying network. Occupies layer-4 in the OSI model.

LAN—Local Area Network

WAN—Wide Area Network, a network that typically connects distant sites to one another or to the public Internet. The public Internet is considered a WAN.

VPN—Virtual Private Network. A layer-2 and/or layer-3 networking technology that allows local networks to be securely extended or bridged over WANs, such as the public Internet.

Endpoint—An endpoint is any device that is physically an end point on a network. Laptops, desktops, mobile phones, tablets, servers, and virtual environments can all be considered endpoints.

Threads—A thread is the unit of execution within a process. A process can have anywhere from just one thread to many threads. In computer science, a thread of execution is the smallest sequence of programmed instructions that can be managed independently by a scheduler, which is typically a part of the operating system. The implementation of threads and processes differs between operating systems, but in most cases a thread is a component of a process. Multiple threads can exist within one process, executing concurrently and sharing resources such as memory, while different processes do not share these resources. In particular, the threads of a process share its executable code and the values of its dynamically allocated variables and non-thread-local global variables at any given time. processes are typically independent, while threads exist as subsets of a process. Processes carry considerably more state information than threads, whereas multiple threads within a process share process state as well as memory and other resources.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

In computing, data flow is a broad concept, which has various meanings depending on the application and context. In the context of software architecture, data flow relates to stream processing or reactive programming. Data flow is a software paradigm based on the idea of disconnecting computational actors into stages (pipelines) that can execute concurrently. The data-centric perspective characteristic of data flow programming promotes high-level functional specifications and simplifies formal reasoning about system components. In computing, a process is the instance of a computer program that is being executed by one or many threads. It contains the program code and its activity. Depending on the operating system, a process may be made up of multiple threads of execution that execute instructions concurrently. While a computer program is a passive collection of instructions typically stored in a file on disk, a process is the execution of those instructions after being loaded from the disk into memory. Several processes may be associated with the same program; for example, opening up several instances of the same program often results in more than one process being executed.

A data-flow graph (DFG) is a graph which represents data dependencies between a number of operations, for example, with a process. Consider any algorithm is comprised of a number of ordered operations. Since examples are always better than words, consider the procedure for finding the root of a quadratic equation

$$x = \frac{- b \pm \sqrt{{b}^{2} - 4 ac}}{2 a}$$

In which a, b, and c are the elements of the real roots of the quadratic equation.

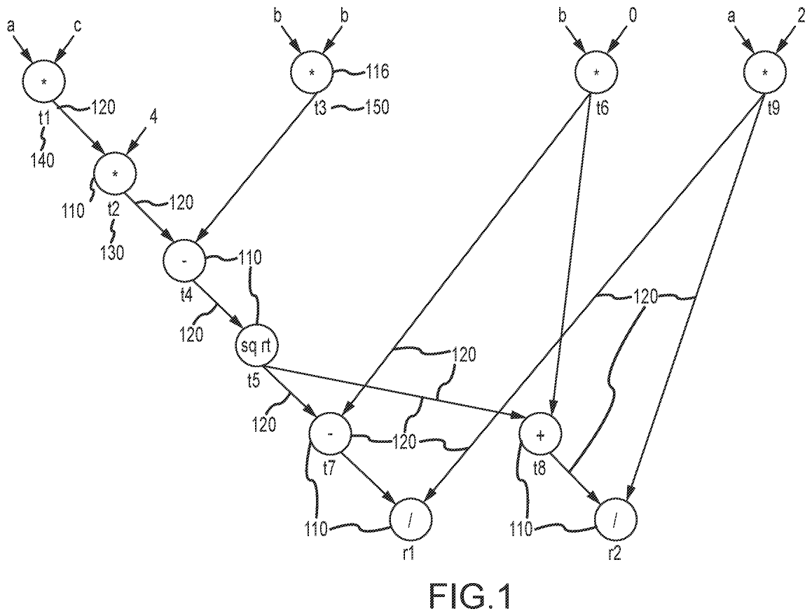

FIG. 1 is a data path graph 100 for the quadratic equation. As processes are executed as shown in circles 110 the resultant data 120 is directed to the next process. In this instance,
t1=a*c;
t2=4*t1;
t3=b*b;
t4=t3−t2;
t5=sqrt(t4);
t6=−b;
t7=t6−t5;
t8=t7+t5;
t9=2*a;
r1=t7/t9;
r2=t8/t9

One could implement this algorithm line by line, but a more general realization would note the dependencies between each operation. For example, t2 130 cannot be computed before t1 140, but t3 150 could be computed before t1 140 or t2 130.

Data may also flow, or the path of data may be directed, to another process within the same machine, via a thread, or even to a process on a different machine operating at a distant location, Each thread, process, or machine interacts with the source of that data differently. Each path from the data source to the data processing function is unique and while there are similarities and opportunities for combine paths, endpoints and the like the communication protocols for each are distinct. In some instances, it merely informs the process where to look for the data or to share an instantiation of the data. In other instances, the communication protocol includes opening a pipe for streaming data on which to act.

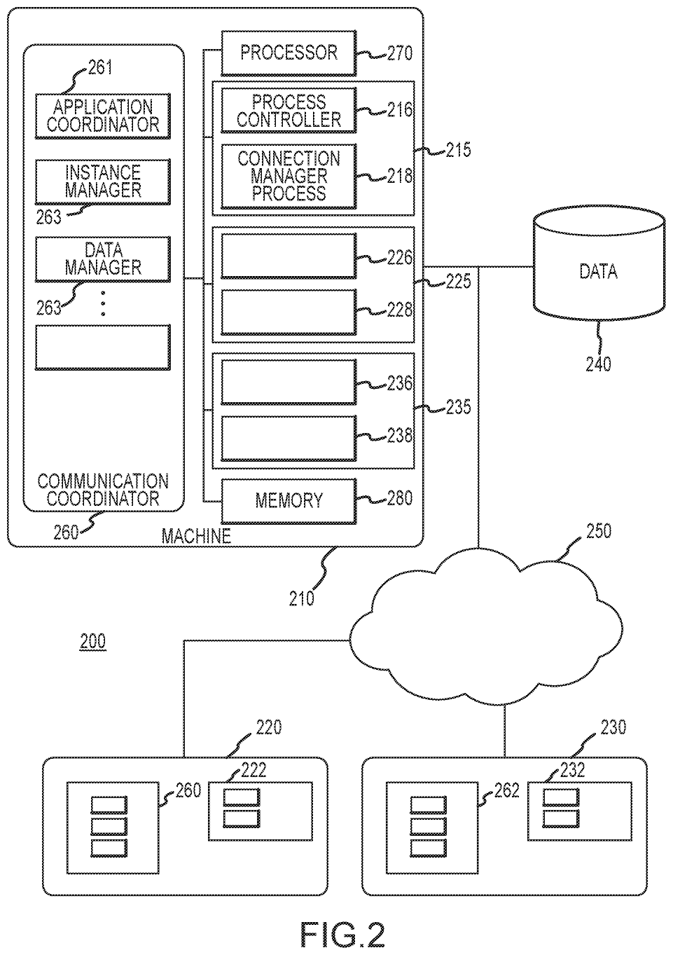

FIG. 2 is a high-level block diagram of a system architecture 200 for data stream processing and visualization according to one embodiment of the present invention. The rendition in FIG. 2 presents three machines 210, 220, 230 communicatively coupled to a data source 240 via a network 250 such as a wide area network (Internet) or a local area network. The first machine 210 is expanded to present a communication coordinator 260 communicatively coupled to an internal processor 270 and non-transitory memory media 280. Three data functionality processes 215, 225, 235 or applications are presented graphically as associated with machine 1 210 with two additional data functionality processes 222, 232 associated with machine 2 220 and machine 3 230, respectively. One of reasonable skill in the art will recognize that the memory 280 represents a collections of instructions embodied as code which when executed by the processor 270 instantiated on the machine form one or more processes. These processes can be, and are in this depiction, the communication coordinator 260 and associated data functional processes 215, 225, 235. Other processes and hardware components normally associated with a machine of this type are not shown but are well known. The other machines 220, 230 possess the same architecture, albeit not shown in complete detail.

The communication coordinator 260, resident on each machine, includes, among other things, an application coordinator 261, instance manager 262 and a data manager 263. Each process or application instantiation is associated with a process controller 216, 226, 236 and a connection manager 218, 228, 238. A user interface (not shown) provides direct user input to the communication coordinator 260 as to the specific needs or data processing requirements. In other embodiments directives regarding data processing may originate from other processes, machines or the like.

The communication coordinator 260 is responsible for executing administrative commands and maintains instantiations related to processes participating in identified requirements. Process availability and other managed applications relevant to each assigned task, and associated requirements, are coordinated on each machine with similar communication coordinators.

The application coordinator 261 is responsible for establishing and managing the distributed and on-site processes. It is further associated with the:
Data Manager 263—Responsible for maintaining and managing instance data files per process instance.
Instance Manager 262—Responsible for maintaining and managing instance configuration regarding streaming data. Manages configuration of distributed processes, including connectivity with the connection manager of each process to connect to peers.

The process controller 216, 226, 236 receives instructions to apply data processing functionalities on a streaming data source 240. Within that set of instructions may include requirements to initiate one or more function calls, threads or seek further actions from other processes. Upon recognizing a need for additional resources, the process controller 216, 226, 236 coordinates with the connection manager to creates a data path.

Just as machine 1's communication coordinator 260 may initiate data processing functionalities resident on machine 1, 2 or 3, a different machine, for example, machine 2 220, may initiate data processing functionalities, acting on the same or different data streams, resident on the same or different machines. The application coordinator, instance manager and data manager resident on that machine coordinates processing resources.

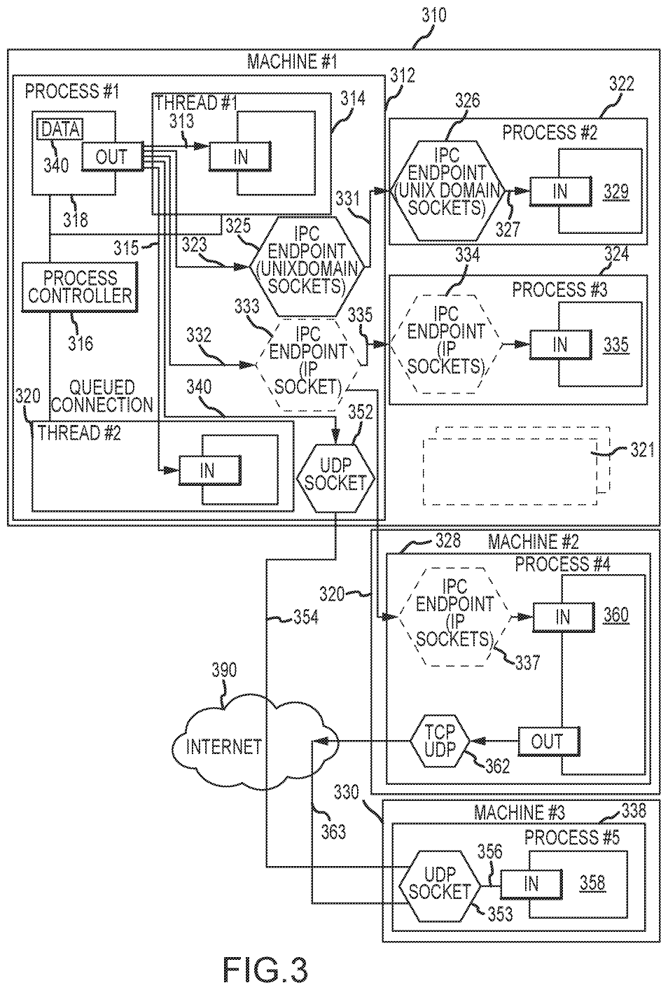

FIG. 3 a graphical rendition of data flow paths for data stream processing and visualization according to one embodiment of the present invention. According to one embodiment of the present invention, data processes acting on streaming data are engaged are engaged and disengaged freely. This rendering identifies three machines 310, 320, 330 and plurality of data processes. Streaming data 340 from a data source (not shown) is gathered and collected by process 1 312 of machine 1 310 and directed to 6 distinct actions. In one instance, process 1 312, machine 1 310, requires two independent unit actions to be carried out. A first thread 314 is initiated to carry out a certain function followed by a second thread 320. A schedule within process 1 312 schedules the connection such that the first thread 314 occurs prior to the second 320. In this case the second connection is queued to enable the first thread 314 to execute prior to beginning the second thread 320.

Upon recognizing that the unit action of thread 1 314 is required (or desired) a connection manager 320 in communication with a process controller 316 initiates a data path 313 with data processing function associated with thread 1 314. As the action is internal to process 1 312, the communication is scheduled by and controlled by the process 312. Once the unit action is complete a reciprocal data path is initiated (not shown) providing the connection manager 318 and ultimately the process controller 316 with actionable results. One of reasonable skill in the relevant art will recognize that the data flow paths of each unit action, thread, process, and the like shown in FIG. 1 may include a reciprocal or otherwise directed out flows.

The execution of process 1 312 also necessitates, in this example, a second unit action or function call. This second thread 320 is queued by a scheduler (process controller 316) in this example to occur after the actions of thread 1 314 are complete. Nonetheless the connection manager initiates a separate and independent data path 315 with the data processing function associated with thread 2 320.

Concurrently the connection manager 318 recognizes other data processing needs to be acted upon and initiates communication handshakes, data paths, with each respectively. In this example two other processes, process 2 322 and process 3 324, reside on the same machine 310 while processes 4 328 and 5 338 reside on other machines.

Unlike threads 1 314 and 2 320 which reside withing process 1 312, process 2 322 and process 3 324 are separate applications. In a practical implementation these may be programs that, while residing on the same machine, have a completely different functionality and are directed to a different data processing analytic or rendering. In one example they may provide metrics of a data spectrum while in another a process may provide a graphical rendering of the data. Each requires the streaming data and acts on the data contemporaneously, but each has unique communication protocol requirements. Other additional processes 321 may also be available either on machine 1 310 or residing elsewhere.

For example, assume process 2 322 is a Unix/Linux based process using a Unix domain socket. A socket is one endpoint of a two-way communication link between two programs. A socket is bound to a port number so that a communication layer can identify the application that data is destined to be sent. In this instance two inter-process communication Unix endpoints form a path between process 1 312 and process 2 322. The connection manager 318 of process 1 312 also establishes a data path 323 from the data source 340 associated with process 1 312 to the process 1 Unix IPC endpoint 325. Similarly, the process 2 Unix IPC endpoint 326 establishes a data path 327 from the process 2 Unix IPC endpoint 326 to the process 2 data processing functionality 329. The connection manager 318 understands, as described below, that to engage process 2 322 on machine 1 310, a Unix IPC data 331 path must be formed.

As with process 2 322, process 3 324 also requires an IPC data path. In this case an TCP/IP protocol is recognized by the connection manager 318. As with process 2 322, the connection manager 318 establishes a data path 332 from the data source 340 to the IPC endpoint having a TCP/IP socket 333. Process 3's IPC endpoint 334 using TCP/IP protocols establishes a data path 335 from the process 1's TCP/IP socket IPC endpoint 333 to the process 3 IPC's endpoint 334. The path continues from process 3's IPC, TCP/IP socket 334 to process 3 data functionality 335.

While each data path is independent, the connection manager 318 recognizes the same original data path may have two or more branches having different ultimate destinations. In this example both process 3 324, resident on machine 1 310, and process 4 328, resident on machine 2 320 require a data path using an IPC endpoint operating on a TCP/IP communication protocol. Accordingly, the same data path 322 from the data source 340 associated with process 1 312 to the IPC endpoint having a TCP/IP socket 333 can be used. From that point two separate paths can branch. One path 335 is directed to process 3's IPC endpoint 334 and a separate path 336 is directed to process 4's IPC endpoint 337, also having a TCP/IP socket.

The data process functionality associated with process 5 338 is instantiated on machine 3 330. In this example machine 3 330 is located apart from machine 1 310, process 1 312 and communicatively coupled to machine 1 310 via a wide area network 390 such as the Internet. While data communications can take place between disparate machines using TCP/IP protocols, the present invention's flexibility enables multiple types of communication protocols to be invoked at run time without altering the continuous flow of data to any preexisting data paths. In this example, the data paths 313, 323, 332, and data processing functionality of threads 1 and 2, and processes 2, 3, and 4 are ongoing when a new requirement is recognized necessitating the implementation of the data processing functionality of process 5 338 located on machine 3 330.

Connections to process 5 338, machine 3 330 are recognized by the connection manager 318 to be UDP based. The connection manager 318 establishes a data path 350 from the data source 340 associated with process 1 312 to a UDP socket 352. Process 5's UDP's socket 353 establishes a handshake with the process 1's UDP socket 352 to form a data path 354 from the process 1's UDP socket 352 to the process 5's UDP's socket 353 on machine 3 330. Process 5 338 thereafter establishes a path 356 from process 5's UDP socket 353 to process 5 data functionality 358.

Process 5 338 in this instance also receives and acts upon resultant data from process 4 328, machine 2 320. A separate connection manager (not shown) establishes a data path 361 from the resulting data from the process functionality 360 associated with process 4 328 to an outgoing UDP socket 362 resident on machine 2 328. Process 5's receiving UDP's socket 353 establishes a handshake with the process 4's outgoing UDP socket 362 forming a separate data path 363 from the process 4's UDP socket 362 on machine 2 320 to the process 5 UDP's socket 353 on machine 3 330. Process 4's established data path 356 from process 4's UDP socket 353 to process 5's data functionality 358 completes the data path.

Recall, a network socket is a software structure within a node of a computer network that serves as an endpoint for sending and receiving data. The structure and properties of a socket are defined, in one embodiment, by an application programming interface (API) for the networking architecture. Sockets are created only during the lifetime of a process of an application running in the node.

Because of the standardization of the protocols the term network socket is most commonly used in the context of the Internet Protocol Suite and is therefore often also referred to as Internet socket. In this context, a socket is externally identified to other hosts by its socket address, which is the triad of transport protocol, IP address, port number and the like.

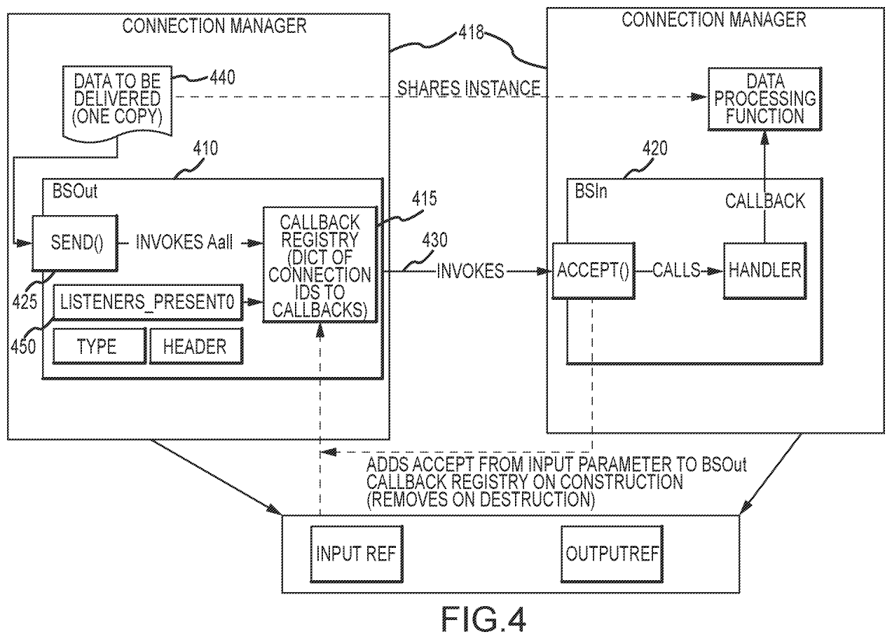

FIG. 4 is an expanded view of a connection manger 418 exchange between two communication endpoints 410, 420, according to one embodiment of the present invention. As a process identifies a need for additional data analytical functionalities, the process controller directs the connection manager 418 to initiate a data path 430. The outgoing connection manager agent 410 receives an instruction 425 to send information, including access to the data stream 440, to a targeted thread, process or machine. The outgoing connection manager 410 accesses a callback registry 415 to locate a communication protocol (connection identification) for a particular process. Each outgoing connection manager 410 includes listeners 450 that recognize communication protocols from other receiving connection manger agents 420. For example, an internal thread communication may simply need information by which to access a data instantiation. A process resident on the same machine may require additional information regarding IPC protocols.

The callback registry 415 maintains a list of active communication protocols so that when a connection manager 410 seeks access to a particular process, the connection manager 410 can view the callback registry 415 and properly initiate a data path 430 to an appropriate receiving connection manager 420. Each segment in the data path is managed by a connection manager agent pair. For example, and with additional reference to FIG. 3, the process initiated in machine 1 310 has identified 5 separate and independent data paths 313, 323, 332, 350, 315. Each data path includes one or more connection manager pairs to establish each data path.

The path from the original connection manager 318 outgoing agent for each thread (thread 1 and thread 2) involves a single connection manager agent pair. The process controller 316, working with the connection manager 318 can delay or queue the data path to thread 2 320. For the remaining three data paths additional connection manager pairs are engaged.

The original connection manager 318, recognizing a need to engage additional data processing functionalities, initiates the creation of a data path to each process. To do so the callback registry identifies that for process 2 322, access must be gained through an IPC endpoint using a Unix domain socket 325. Process 3 324 and process 4 328 on machine 2 320 can each be accessed via an IPC endpoint using TCP/IP protocols 333. And process 5 338 resident on machine 3 330 can be reached using an UDP socket 352.

Each segment within each data path includes a separate connection manager agent pair. For example, the data path from the original requirement in process 1 312 of machine 1 310 to process 2 322, also resident on machine 1 310, includes 3 segments. The first segment 323 is from the process 1 312 to the IPC endpoint, Unix domain socket 325. In this segment the outgoing process 1 connection manager 318 agent identifies from the callback registry communication protocols to convey the data path to the receiving connection manager receiving agent for the IPC endpoint, Unix domain socket 325. The IPC endpoint, Unix domain socket 325 also includes its own outgoing connection manager agent, and callback registry. This registry identifies communication protocols for the receiving IPC endpoint, Unix domain socket 326 associated with process 2 322, forming the second connection manager agent pair. Similarly, the receiving IPC endpoint, Unix domain socket 326 associated with process 2 322, includes an outgoing IPC endpoint, Unix domain socket (not shown). In its callback registry it possesses communicating protocols to connect with the receiving agent for process 2 functionality 329, forming the third communication manager agent pair. The data path from process 1 312, machine 1 310, to process 2 322, machine 1 310 includes three connection segments and 3 communication manager agent pairs. The present invention provides flexibility to couple communication segments as necessary to create an appropriate data path for real time streaming data analytics.

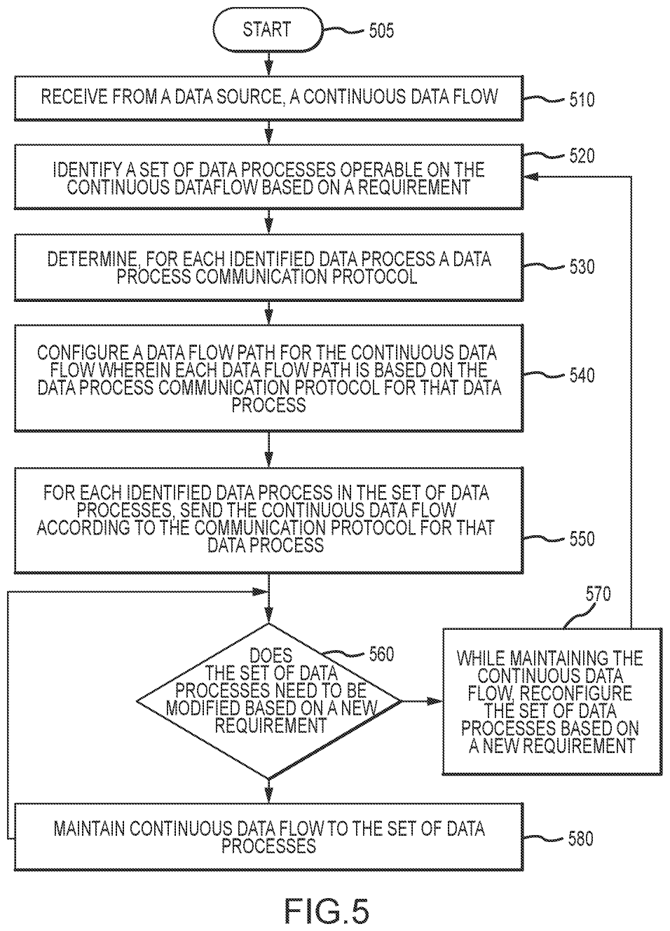

One process by which data streams are processed and visualized is depicted in FIG. 5. The flowchart of FIG. 5 depicts an example of the methodology which may be used process and visualize streaming data. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

The process begins 505 with receiving 510 streaming data from a data source. Streaming data is, as described herein, a continuous flow of data. The present invention enables various data analytics to be performed on the data at will. Data functionalities, visualizations, analytics, and the like can be initiated and discontinued without altering other ongoing data analytic processes. In a sense, the invention allows the plumbing of a house to be modified without turning off the water.

With the reception of streaming data ongoing, a set of data processes is identified 520 based on a requirement. The requirement may include modification of the data into a different format, filtering of the data or for example, identification of certain narrowband IQ data from otherwise wideband IQ data. Other processes may be a graphic or visual rending of the data. These requirements are received by a communication coordinator with various applications managed by an application coordinator. Each process thereafter identifies further resource needs. A visualization process may require that the data format be changed, or that certain data be extracted from the data stream for rendering. For each process recognized (application) by the communication manager certain communication protocols are identified 530.

A data path is thereafter configured 540 for the continuous flow of data based on the communication protocols for that data process/functionality. Once the data path is configured, streaming data is accessible 550 by the associated data processing functionality.

The process is not static. As previously mentioned, the present invention enables data processing functionalities to begin and end without disruption of other ongoing data processing functionalities. As requirements and needs change the present invention creates new data paths while at the same time terminating and/or maintaining others. The process flowchart of FIG. 5 includes a query 560 in which asks whether the data processes need to be modified based on a new requirement. An affirmative response to the query reenters the process by once again identifying 570 a set of data processes based on the new requirement. This iterative process continues until the data stream terminates or the requirements/needs cease. When the response to the query is in the negative, the data flow to existing data processes is maintained 580.

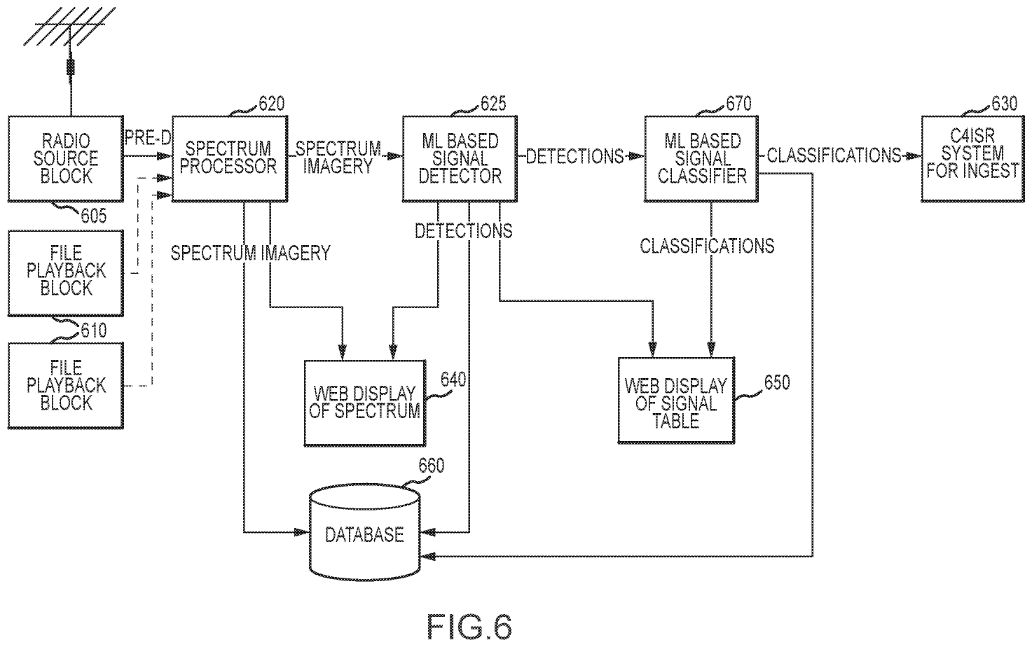

An example of the present invention in practice is illustrated in FIG. 6. FIG. 6 presents an example of radio frequency data analysis and visualization according to one embodiment of the present invention. In this instance streaming data in the form of wideband radio frequency data is collected and presented to a spectrum processor. In one instance the data stream may originate from real time collection via an antenna or the like 605 while in other implementations the data stream may originate from one or more file playback modalities 610. Pre-modulated data arrives at the spectrum processor 620 in which other requirements are levied on the data.

In the example depicted in FIG. 6, 4 requirements on which to act on the data have been identified. These requirements include preparation of the data for consumption by a C4ISR system 630, display of RF spectrum associated with the streaming data 640, display of a signal table including machine learned signal detections and classifications 650, and lastly the storage of the data in three separate formats in a database 660.

In each case the process begins with spectrum processor 620. The process controller of the spectrum processor 620 recognizes a need for 6 data paths. A first data path begins with the spectrum processor 620 and ends with the database 660. As previously described a connection manager facilitates this direct data path although it may include one or more segments.

A second data path again begins with the spectrum processor 620 and ends with a web display of the RF spectrum. The process by which to display the RF spectrum recognizes that the data delivered by the spectrum processor 620 is alone, inadequate. Spectral imagery provided to a Machine Learning (ML) based signal detector 625 is also needed. A path from the spectrum processor 620 to a ML based signal detector 625 is thereafter directed to the web RF spectrum display process 640.

Storage of data from the ML based signal detector 625 is also identified as a requirement. A third path therefore exists from the spectrum processor 620 to the ML based signal detector 625 ending with storage at the database 660. The connection manager at the ML based signal detector 625 therefore receives the data stream from the spectrum processor 620 but directs it thereafter to both the web-based display 640 of the RF spectrum and the database 660. The connection manager of the ML based signal detector 625 also acts as an intermediary for a data path to a display of a signal table 650 and for data to be ingested by the C4ISR system 630.

The display of a signal table 650 forms a 4th data path from the spectrum processor 620 and like the spectrum display 640, it too requires additional data. In this case data from a ML based signal classifier 670. The data stream is directed to the ML based signal classifier 670 from the ML based signal detector 625 and ultimately to the signal table display process 650. Data from the ML based signal classifier 670 is further directed to the C4ISR system 630 and to the database for storage. In both the path to storage 660 and to the C4ISR system 630, the data path includes no less than three segments, each with a connection manager agent pair. In actuality there may be many more segments as any one of these processes may be located on different machine or at a different location.

As mentioned, the formation and termination of data paths associated with the present invention is dynamic. If for instance, the display of a web-based signal table is terminated, the remaining paths remain unaltered. Similarly, if the process for the web base signal table (or any other process) is reinitiated the other existing data functionalities and data paths remain unchanged.

The present invention provides a system and associated methodology for dynamic and reconfigurable data paths. Data analytics on streaming data is conducted, in one embodiment of the present invention, upon the identification of data processing needs or requirements. As these needs are recognized data paths are formed providing each data processing functionality with access to a data source. As requirements change, new data processing functionalities requested or existing functionalities terminated, the invention terminates existing and creates new data paths, all while maintaining other data paths for data processing that is ongoing.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

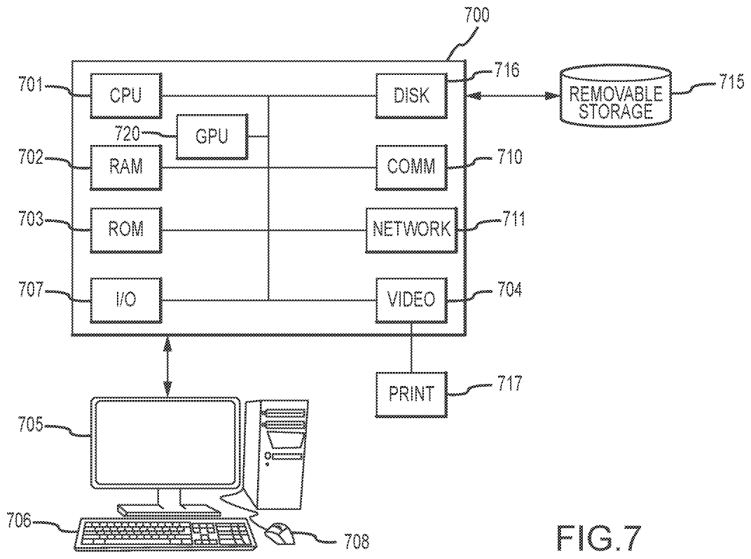

One of reasonable skill will also recognize that portions of the present invention may be implemented on a conventional or general-purpose computing system, such as a personal computer (PC), server, a laptop computer, a notebook computer, a handheld or pocket computer, and/or a server computer. FIG. 7 is a very general block diagram of a computer system in which software-implemented processes of the present invention may be embodied. As shown, system 700 comprises a central processing unit(s) (CPU) or processor(s) 701 coupled to a random-access memory (RAM) 702, a graphics processor unit(s) (GPU) 720, a read-only memory (ROM) 703, a keyboard or user interface 706, a display or video adapter 704 connected to a display device 705, a removable (mass) storage device 715 (e.g., floppy disk, CD-ROM, CD-R, CD-RW, DVD, or the like), a fixed (mass) storage device 716 (e.g., hard disk), a communication (COMM) port(s) or interface(s) 710, and a network interface card (NIC) or controller 711 (e.g., Ethernet). Although not shown separately, a real time system clock is included with the system 700, in a conventional manner.

CPU 701 comprises a suitable processor for implementing the present invention. The CPU 701 communicates with other components of the system via a bi-directional system bus 720 (including any necessary input/output (I/O) controller 707 circuitry and other “glue” logic). The bus, which includes address lines for addressing system memory, provides data transfer between and among the various components. Random-access memory 702 serves as the working memory for the CPU 701. The read-only memory (ROM) 703 contains the basic input/output system code (BIOS)—a set of low-level routines in the ROM that application programs and the operating systems can use to interact with the hardware, including reading characters from the keyboard, outputting characters to printers, and so forth.

Mass storage devices 715, 716 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 7, fixed storage 716 stores a body of program and data for directing operation of the computer system, including an operating system, user application programs, driver and other support files, as well as other data files of all sorts. Typically, the fixed storage 716 serves as the main hard disk for the system.

In basic operation, program logic (including that which implements methodology of the present invention described below) is loaded from the removable storage 715 or fixed storage 716 into the main (RAM) memory 702, for execution by the CPU 701. During operation of the program logic, the system 700 accepts user input from a keyboard and pointing device 706, as well as speech-based input from a voice recognition system (not shown). The user interface 706 permits selection of application programs, entry of keyboard-based input or data, and selection and manipulation of individual data objects displayed on the screen or display device 705. Likewise, the pointing device 708, such as a mouse, track ball, pen device, or the like, permits selection and manipulation of objects on the display device. In this manner, these input devices support manual user input for any process running on the system.

The computer system 700 displays text and/or graphic images and other data on the display device 705. The video adapter 704, which is interposed between the display 705 and the system's bus, drives the display device 705. The video adapter 704, which includes video memory accessible to the CPU 701, provides circuitry that converts pixel data stored in the video memory to a raster signal suitable for use by a cathode ray tube (CRT) raster or liquid crystal display (LCD) monitor. A hard copy of the displayed information, or other information within the system 700, may be obtained from the printer 717, or other output device.

The system itself communicates with other devices (e.g., other computers) via the network interface card (NIC) 711 connected to a network (e.g., Ethernet network, Bluetooth wireless network, or the like). The system 700 may also communicate with local occasionally connected devices (e.g., serial cable-linked devices) via the communication (COMM) interface 710, which may include a RS-232 serial port, a Universal Serial Bus (USB) interface, or the like. Devices that will be commonly connected locally to the interface 710 include laptop computers, handheld organizers, digital cameras, and the like.

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

While there have been described above the principles of the present invention in conjunction with data stream processing and visualization, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

What is claimed is:

1. A method for data flow management, the method comprising:
receive from a data source, a continuous data flow;
identify, from one or more available data processes, a set of data processes operable on the continuous data flow based on a requirement;
determine, for each identified data process in the set of data processes, a data process communication protocol;
configure, for each identified data process in the set of data processes, a data flow path for the continuous data flow wherein the data flow path is based on the data process communication protocol for that data process;
send, for each identified data process in the set of data processes, the continuous data flow according to the communication protocol for that data process; and
while maintaining the continuous data flow, reconfigure the set of data processes based on a new requirement.

2. The method for data flow management according to claim 1, wherein the data source is a historical data file.

3. The method for data flow management according to claim 1, wherein the data process communication protocol for each identified data process is based on a data volume requirement for that identified data process.

4. The method for data flow management according to claim 1, wherein each data process communication protocol is selected from a predetermined list.

5. The method for data flow management according to claim 1, wherein each data flow path is configured independently from each other data flow path.

6. The method for data flow management according to claim 1, wherein a single data flow path is associated with two or more data processes.

7. The method for data flow management according to claim 1, wherein one or more data flow paths are dependent on one or more other data flow paths.

8. The method for data flow management according to claim 1, wherein the data process communication protocol for at least one data process is a thread within an identified data process.

9. The method for data flow management according to claim 1, wherein the data process communication protocol for at least one data process is an inter-process communication on a common machine.

10. The method for data flow management according to claim 1, wherein the data process communication protocol for at least one data process is a TCP/IP communication across a network.

11. The method for data flow management according to claim 1, wherein the data process communication protocol for at least one data process is a UDP communication across a network.

12. The method for data flow management according to claim 1, wherein responsive to the set of data processes being modified, maintain the data flow to data processes in the set of data processes that are unaltered.

13. The method for data flow management according to claim 1, wherein configuring includes invoking a call to the identified data process based on accepted input parameters maintained in a data process communication protocol registry.

14. A system for data flow management, the system comprising:
a data source configured to deliver a continuous data flow;
one or more available data processes;
a set of data processes formed from the one or more available data processes operable on the continuous data flow based on a requirement;
a data process communication protocol registry having a data process communication protocol for each identified data process in the set of data processes;
a data flow path for the continuous data flow configured for each identified data process in the set of data processes, wherein the data flow path is based on the data process communication protocol for that data process;
a processor communicatively coupled to a non-transitory computer-readable storage medium tangibly embodying a program of instructions, executable by the processor, for
receiving, for each identified data process in the set of data processes, the continuous data flow according to the communication protocol for that data process; and
responsive to receiving a new requirement, reconfiguring the set of data processes while maintaining the continuous data flow.

15. The system for data flow management according to claim 14, wherein the data source is a historical data file.

16. The system for data flow management according to claim 14, wherein the data process communication protocol for each identified data process is based on a data volume requirement for that identified data process.

17. The system for data flow management according to claim 14, wherein each data flow path is independent from each other data flow path.

18. The system for data flow management according to claim 14, wherein a single data flow path is associated with two or more data processes.

19. The system for data flow management according to claim 14, wherein the data process communication protocol for at least one data process is a thread within an identified data process.

20. The system for data flow management according to claim 14, wherein the data process communication protocol for at least one data process is an inter-process communication on a common machine.

21. The system for data flow management according to claim 14, wherein the data process communication protocol for at least one data process is a TCP/IP communication across a network.

22. The system for data flow management according to claim 14, wherein the data process communication protocol for at least one data process is a UDP communication across a network.

23. The system for data flow management according to claim 14, wherein responsive to the set of data processes being reconfigured, maintain the data flow to unmodified data processes in the set of data processes that are unaltered.
